(19) United States
(12) Patent Application Publication
(10) Pub. No.: US 2009/0027287 A1
(43) Pub. Date: Jan. 29, 2009

(54) Systems and methods for communications through materials

(76) Inventor: John Menner, Clifton, VA (US)

Correspondence Address: ANDREWS KURTH LLP;Intellectual Property Department, Suite 1100, 1350 I Street, N.W., Washington, DC, 20005, US

(21) Appl. No.: 12/219,569

(22) Filed: Jul. 24, 2008

Related U.S. Application Data
(60) Provisional application No. 60/961,814, filed on Jul. 24, 2007.

(51) Int. Cl. H01Q 19/06

(52) U.S. Cl. 343/753

(57) ABSTRACT

A system and a method for communicating through materials are provided. One exemplary system is an antenna system for communicating through materials. The antenna system includes an antenna conductor that transmits an electromagnetic field bi-directionally, a lens layer that compresses the wavelength of the electromagnetic field and a backing material that re-directs the electromagnetic field in a chosen direction. The re-directed, compressed electromagnetic field has a sufficient frequency and power for the antenna system to effectively sense or transmit through a chosen material.

### CROSS REFERENCE TO RELATED APPLICATION(S)

This application claims priority from U.S. Provisional Application 60/961,814 filed Jul. 24, 2007 entitled “COMMUNICATIONS THROUGH MATERIALS” the content of which is incorporated herein in its entirety to the extent that it is consistent with this invention and application.

### BACKGROUND

In many real life emergency cases for example in mine explosions, it is necessary to communicate through some electrically lossy or conductive material such as clay or wet earth directly to the surface for rescue or directly from the surface into a mine, deep underground. In other cases, it may be important to have sensors from deep wells communicate information directly to the ground or sea surface. When underground in mines, caves, or inside buildings and cities, it is desired to communicate with first responders. Currently available techniques cannot effectively accomplish this for any appreciable distance without impractically very large antennas if even then. Such antenna systems, if possible, would not be practical due to size and cost for most situations, prohibitively expensive, massive, non-transportable, etc.

Moreover, as the physical size of the electrical conductor of the antenna becomes small with respect to the wavelength the antenna is trying to radiate, the electromagnetic power radiated decreases by the fourth power of the wavelength. Consequently, the radiated efficiency decreases to a small percentage of the power inserted into the antenna.

Accordingly, there is a need to reduce the physical size of the electrical conductor of the antenna without sacrificing radiated efficiency. As such, there is a need to reduce the physical size of the electrical conductor that is needed to match to the radiated wavelength.

### SUMMARY

An advantage of the embodiments described herein is that they overcome the disadvantages and meet the needs described above. These advantages and others are provided by an antenna system for communicating through materials. The antenna system includes an antenna conductor that transmits an electromagnetic field bi-directionally, a lens layer that compresses the wavelength of the electromagnetic field and a backing material that re-directs the electromagnetic field in a chosen direction. The re-directed, compressed electromagnetic field has a sufficient frequency and power for the antenna system to effectively sense or transmit through a chosen material.

These advantages are also provided by an antenna system for communicating through materials. The antenna system includes an antenna conductor that transmits an electromagnetic field bi-directionally, a lens layer that compresses the wavelength of the electromagnetic field, a backing material that is highly relatively directionally magnetically permeable and re-directs the electromagnetic field in a chosen direction, and an enclosure hermetically enclosing antenna conductor, lens layer and backing material. The re-directed, compressed electromagnetic field has a sufficient frequency and power for the antenna system to effectively sense or transmit through a chosen lossy material. The antenna conductor is configured as a loop and the lens layer is highly electrically conductive and highly relatively magnetically permeable.

These advantages and others are achieved also by a method for communicating through materials. The method includes determining a material to be communicated through, calculating a necessary frequency and radiated power for communicating through the material, determining size limitations for antenna, calculating necessary wave compression, based on size limitations, necessary frequency and radiated power, selecting wave compressing component, selecting antenna conductor material and configuration, and selecting backing material and configuration. The backing material is highly relatively directionally magnetically permeable and re-directs the electromagnetic field in a chosen direction. The re-directed, compressed electromagnetic field has a sufficient frequency and power for the antenna system to effectively sense or transmit through the determined material

### DESCRIPTION OF THE DRAWINGS

The detailed description will refer to the following drawings, wherein like numerals refer to like elements, and wherein:

FIGS. 1A-1B are block diagrams illustrating embodiments of a system for communicating through materials.

FIGS. 2A-2C are block diagrams illustrating embodiments of a system for communicating through materials.

FIG. 3 is a block diagram illustrating an embodiment of a system for communicating through materials.

FIG. 4 is a block diagram illustrating another embodiment of a system for communicating through materials.

FIG. 5 is a block diagram illustrating another embodiment of a system for communicating through materials.

FIG. 6 is a flowchart illustrating an embodiment of a method for communicating through materials.

### DETAILED DESCRIPTION

Described herein are systems and methods for communicating through materials. Embodiments provide an antenna that enables such communications. In order to enable such communications, one goal of the embodiments described herein is to reduce the physical size of the electrical conductor needed to match to the radiated wavelength. This can be accomplished by reducing the size of the electromagnetic wavelength through wave compression in the antenna structure itself.

Another goal achieved by the embodiments described herein is to further reduce the physical size of the antenna conductor by creating non-mutually inductive antenna conductor segments; this increases the effective length of the antenna. If segments of the antenna conductor are mutually inductive, they shorten the effective conductor length because of the field influence each mutually inductive segment has on each other. Embodiments described herein accomplish this (the non-mutually inductive antenna conductor segments) by creating geometrical channels for directing the magnetic (B) fields on the antenna conductor arms away from other antenna elements. The geometrical channels have high permeability but low electrical conductivity and do not interfere with the radiating patterns of the other antenna conductor segment (whether on the same conductor arm or other arms.

Yet another goal achieved by the embodiments described herein is to use the composition of system components, the structure of embedded materials, and/or gradients of embedded materials to focus or direct the B fields onto targets or in directions never before accomplished with magnetic flux density. This enables constructing a loop antenna with only one lobe for directing a magnetic beam.

As noted above, it is often important or desirable to be able to communicate through materials for a variety of purposes. For example, miners trapped deep underground need to communicate through thousands of feet of rock, clay and other earth. Sea vessels need to be able to communicate through water or through hundreds and thousands of feet of water and rock, clay and other earth to detect sub sea deposits of oil and other material. Mobile phones and other devices in cities often are used in buildings where the buildings interfere with signal reception.

To accomplish such transmissions, a transmitter antenna according to an embodiment is able to use all available energy directionally. Such embodiments provide reasonable size antennas. Ideally, such antennas may be used without the possibility of sparks. The design characteristics of an embodiment of such an antenna include, e.g.:

a) Directionality using high permeability, variable conductivity materials to direct the magnetic flux density;

b) Design of high permeability, variable conductivity material. Such material may include stratified layers of new materials;

c) Antennas with recursive pattern designs in two (2) or three (3) dimensions that enable an array for beam steering; and

d) Antennas driven by a hermetically-sealed inductor into a single element conductor as primary and secondary of transformer, respectively.

The embodiments described herein use wave compression antennas to solve the problems described above. The idea behind wave compression is to transmit an electromagnetic (EM) wave that is equal or half wavelength with respect to the antenna conductor on which it is to be transmitted. This concept is called antenna matching to the wavelength. High antenna efficiency for propagation demands this relationship in sizes.

In order to propagate signals through lossy materials, however, it is necessary to use low frequencies. Consequently, the antennas necessary to transmit such signals would ordinarily be very large. Such large antennas are not practical or feasible. However, if the EM wave is electromagnetically compressed to be of a small size, then a physically small antenna may be used even though it is at a low frequency.

It is well-known that in the transmission of light (also an EM wave), light is refracted when it passes through water. This refraction occurs because the wavelength of light is being compressed due to dielectric differences between the air and water. The relative dielectric εr of air is unity, εr=1; while the relative dielectric of water is εr=81. What is less widely known is that there are many other materials that also cause EM wave compression. Some of these materials cause EM wave compression due to their dielectric characteristics, others due to their electrical conductivity, and still others due to magnetic permeability. These are all material properties, intrinsic to the materials themselves.

To this end, embodiments described herein provide antennas and antenna systems that generate a necessary frequency EM signal to transmit through the specific lossy material and compress the wave with such materials to make the wavelengths small enough to match a physically small antenna. For example, an EM wave with 1000 Hz frequency in air has a wavelength 300 kilometers long. Ordinarily, it would take a very large antenna to create an efficient propagation. In a limestone mine, that 1000 Hz would have a wavelength 3140 meters long. Using an embodiment described herein, the wavelength may be compressed, for example, to 7.02 meters or even shorter. Consequently, embodiments of loop antennas described herein provide an efficient antenna that is a half wavelength long formed into a loop; with a 7.02 meter compressed wavelength 1000 Hz frequency EM wave, such an antenna (configured as a square loop) may be only 0.875 meters on each side of the square loop. Such an antenna may be configured as a full wavelength square loop antenna may be double that or 1.75 meters on each side of the square loop. Similarly, an embodiment of a 3000 Hz frequency EM wave square loop antenna for a full wavelength is just 1.0 meter on each side of the square loop. In other words, embodiments described herein enable antenna length and size reductions by one, two, and three, and even up to four, significant digits (e.g., 3000 meters to 7 meters).

Mathematically this concept may be expressed in Equation 1 for the complex propagation constant gamma from Maxwell's Equations:

(γ)=α+jβ=[(jωμ(σ+jωε)]½ Eqn. 1;

and for very conductive materials like sea water;

α=β=[2πfμσ]½ Eqn. 2;

λ=2π/β(meters) Eqn. 3;

### Where:

α=attenuation constant; β=propagation constant; f=frequency; μ=permeability in free space times the relative permeability; σ=electrical conductivity; ε=absolute permittivity times relative permittivity; λ=wavelength; equations 2 and 3 show a wavelength for an electromagnetic wave at 1000 Hz frequency in sea water; conductivity of σ=4 Siemens per meter, a wavelength λ, of 50 meters; while in limestone with a conductivity of 0.001 Siemens per meter a wavelength of 3,140 meters. Moreover, as the conductivity and/or the permeability increase the wavelength decreases monotonically.

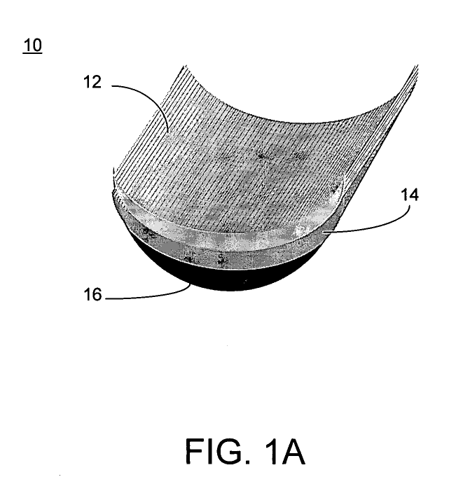

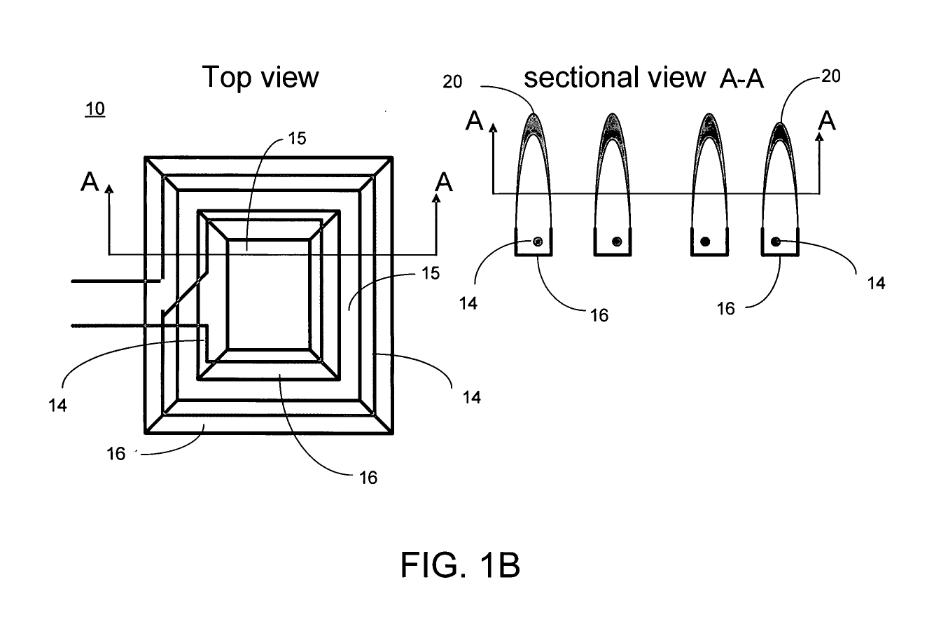

With reference now to FIG. 1A, shown is an embodiment of system 10 for communicating through materials. System 10 achieves the wave or beam compression described above. The embodiment shown includes a stratified, multi-layer design for generating and transmitting a wave-compressed magnetic field. The stratified layers include materials of different characteristics. The layers shown include lens layer 12, antenna conductor layer 14 and backing layer 16. Not shown, but apparent to those of ordinary skill in the art are power supply sufficient to drive antenna conductor 14 and other standard components of antenna systems such as system 10. Lens 12 is a material that is locally conductive. Indeed, in embodiment intended to transmit through lossy materials, lens 12, is highly electrically conductive. High electrical conductivity readily conveys electrical signals but changes the length of the electrical signal waves by compression (i.e., wavelength≈1/√(electrical conductivity x magnetic permeability×frequency)). Therefore, the electrical conductivity of lens 12 compresses the EM signal wavelength. In certain embodiments, a high electrical conductivity of lens 12 would approach the conductivity of a metal (e.g., of copper). In an embodiment, the lens 12 may include high magnetic permeability material, which will also compress the wave length, as shown in the equation above. A high magnetic permeability here is high relative permeability—i.e., permeability relative to free space. A high relative permeability value deforms B fields through the body of the material and amplifies the B field (be realigning the magnetic dipoles in one direction, a high permeable material increases the strength of the B field in that direction). Exemplary high relative permeable materials include iron, some permanent magnets, some rare earth materials, etc. A high permeability value would be, e.g., 5000 or above.

This wave compression, therefore, enables a shorter length antenna conductor 14 to be used and decreases the effective wavelength of the EM field. The wave compression achieved by increasing electrical conductivity and/or magnetic permeability of lens 12 is effective up to the point at which the losses in the back EMF overwhelm any gains made due to improved radiating efficiency from the compressed wavelength. At such point, the back EMF must be reduced through other means. Accordingly, lens 12 is positioned between antenna conductor 14 and direction of transmission of EM field from conductor 14, as shown in FIG. 1A.

It is noted that the embodiment described above is intended for transmitting a signal through lossy materials. In an embodiment intended for transmitting a signal through non-lossy materials, a dielectric lens 12 material may be used. Such lens 12 would have a low electrical conductivity and low magnetic permeability. Alternatively, a high magnetic permeability/low electrical conductivity material may be used with a high permittivity.

Material for lens 12 may be virtually any material that has the above characteristics. For example, lens 12 material may be or include e.g., a dielectric, powdered iron, hydrochloric acid, salt water, super-saturated salt water, combinations of such materials, or other materials etc. Accordingly, lens 12 may be specifically provided for an application by choosing such material and adding to system 10. For example, a dielectric layer may be placed on top of antenna conductor 14 or antenna conductor 14 may be placed in a container of hydrochloric acid. Alternatively, lens 12 may be provided by environment in which antenna conductor 14, and hence system 10, is placed. For example, lens 12 may be provided by placing antenna conductor 14 in salt water, with EM field generated by antenna conductor 14 being transmitted into salt water, which acts as lens 12. Again, there is a limit to the EM wave compression possible without compensation for the eddy current (back EMF) losses in the lossy lens 12 materials. For example, if a copper conductor making up antenna conductor 14 is placed in a lens material with the conductivity of copper, then the back EMF of the copper lens 12 would create losses equal to the power being radiated. In such cases, lens 12 material would have to be laminated like a transformer core or electric motor core to prevent these losses. Additional size reduction in transmitter antenna 14 may be accomplished by winding the antenna conductor 14 in regular less conductive materials but using recursive winding patterns such as an Archimedean or logarithmic spiral.

With continued reference to FIG. 1A, antenna conductor 14 may be a transmitter or a receiver. Antenna conductor 14 shown transmits an EM field. In the embodiment shown, antenna conductor 14 is highly electrically conductive. Indeed, antenna conductor 14 will be as highly electrically conductive as possible, even super-conductive. As such, antenna conductor 14 will generally not have high magnetic permeability. Lens 12 may have a lower electrical conductivity than antenna conductor 14, such as an electrolyte as used in batteries. In other embodiments, lens 12 may have the same or similar conductivity as antenna conductor 14. Regardless, as described above, the transmission of the EM field generated by antenna conductor 14 through lens 12 compresses the field. Importantly, to achieve this effect, there are no electrical shorts between lens 12 and antenna conductor 14; if there were such electrical contact, system 10 would short. In other words, lens 12 is electrically isolated from antenna conductor 14.

Antenna conductor 14 material is chosen to be a good radiator (e.g., radiates 80-100% of power put in). Antenna conductor 14 material may be, for example copper cable or super-conductive ceramics. The number of turns in antenna conductor 14 is application specific.

Ordinarily, a loop or spiral antenna conductor 14, as is preferred in certain embodiments herein, would transmit EM field bi-directionally. In other words, antenna conductor 14 would transmit EM field as a FIG. 8, from the front and back planes of antenna conductor 14. The transmission of the EM field on the back plane of antenna conductor 14 is referred to as a “back lobe.” A back lobe can be particularly problematic or harmful to the material or thing that system 10 is mounted on. For example, if system 10 were mounted on sensitive electronics such back lobe would be harmful to the internal components of the electronics. Consequently, system 10 includes backing material layer 16.

Backing material 16 has a high-relative directional magnetic permeability (i.e., high magnetic permeability relative to 1). In other words, backing material 16 is permeable to EM field in the direction away from the front plane of antenna conductor 14, but not permeable to EM field in direction towards back plane of antenna conductor 14. In this manner, backing material 16 prevents back lobe by trapping EM field generated by antenna conductor 14, causing EM field to reverse or shift direction back towards the front plane of antenna conductor 14.

The configuration and shape of the layers, specifically antenna conductor 14, in system 10 determines placement and configuration of backing material layer 16. If antenna conductor 14 is configured as a loop, backing material layer 16 will be a simple loop on the back side of antenna conductor 14. If, however, antenna conductor 14 is configured as a spiral, embedded squares, rectangles or other simple recursive designs then backing material layer 16 will not be continuous, but will include spaces between segments of the antenna conductor 14 for preventing mutual inductance. In a spiral, embedded square or rectangular configuration, antenna conductor 14 will include channels to guide the B fields in antenna conductor 14 segments. Backing material layer 16 will be provided as channels underneath antenna conductor 14 segments to shield the radiating field.

With reference now to FIG. 1B, shown is an embodiment of system 10 for communicating through materials. FIG. 1B shows both a top view and a cross-sectional view of system 10. In the embodiment shown, antenna conductor is a spiral antenna conductor 14. As shown spiral antenna conductor 14 includes multiple spiral arms. Backing material 16 is configured as channels surrounding segments and arms of spiral antenna conductor 14. The backing material 16 channels define spaces 15 between the segments and arms of spiral antenna conductor 14, as shown. Also as shown, backing material 16 channels are U-shaped so as to best direct magnetic field 20 towards front plane/side of antenna conductor. Magnetic field 20 is shown directed as such in the cross-sectional view in FIG. 1B. The configuration of backing material 16 in channels with spaces 15 prevents mutual induction between antenna conductor 14 segments and arms. Also shown are leads into spiral antenna conductor 14. Lens 12 is not shown.

With continued reference to FIG. 1A, only a portion of antenna conductor 14 is shown; it is not clear from the portion shown whether antenna conductor 14 is configured in a loop or spiral. However, portion of antenna conductor 14 shown is configured in a U-shape, with opening of U-shape on side magnetic waves will be transmitted.

As noted above, antenna conductor 14 may be configured in a recursive antenna pattern. Recursive antenna pattern designs are known to those of ordinary skill in the art. Recursive antennas are used in many industries and applications, included for mobile and wireless device transmissions. A recursive antenna pattern design provides more conductors on a smaller space than other antenna designs. For example, U.S. Pat. No. 6,989,794 to Tran, entitled “Wireless Multi-Frequency Recursive Pattern Antenna,” which is hereby incorporated by reference, describe recursive antennas. Preferred embodiments described herein utilize recursive antenna patterns but not fractal patterns.

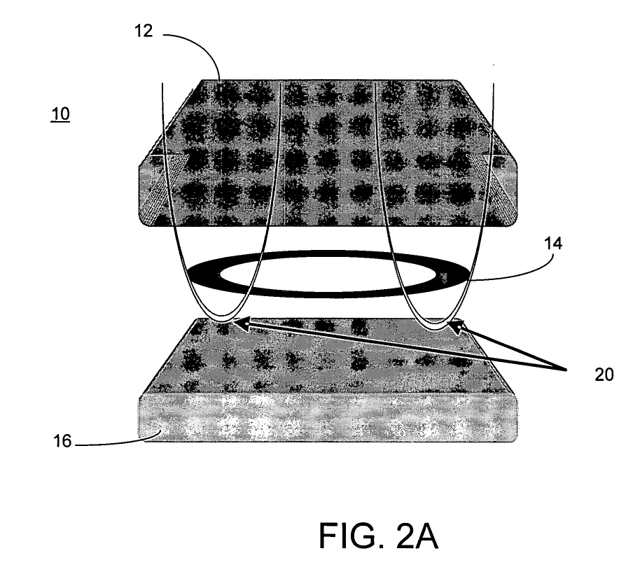

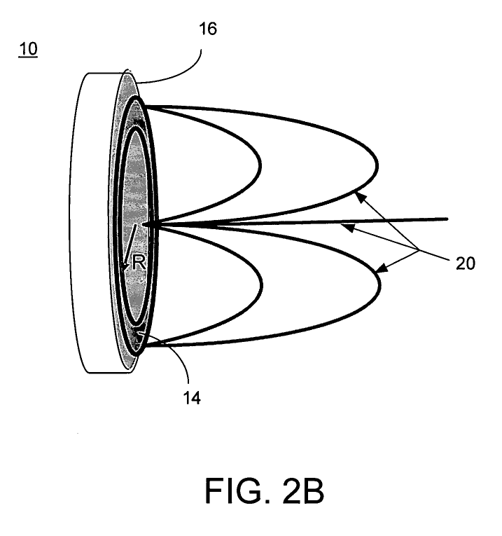

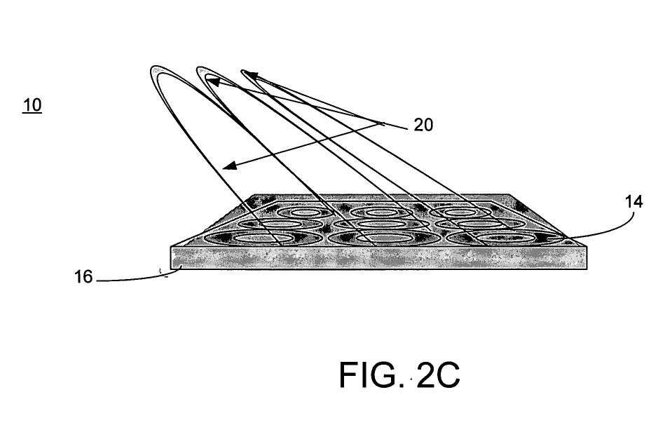

With reference now to FIGS. 2A-2B, shown is an embodiment of system 10 illustrating the operation of system 10. Specifically, FIGS. 2A-2B illustrate the magnetic (B) flux density field 20 generated by system 10, with lens 12 compressing the EM field and permitting only the magnetic part of EM field generated by antenna conductor 14 to pass and backing material layer 16 redirecting back lobes to front B field 20. By redirecting back lobes to front B field 20, backing 16 creates directionality (B field transmitted in one direction). FIG. 2A shows an exploded view of system 10 in operation, while FIG. 2B shows a view of system 10 in operation without lens 12 shown.

As shown, antenna conductor 14 is configured as a loop transmitter. Alternatively, a plurality of loop antenna conductors 14 may be configured in an array, as shown in FIG. 2C. Such an array allows for beam steering of the B field, as shown. For creation of an air-launched wave in a non-lossy medium for long distance communications, the circumference of antenna conductor 14 must be at least thirty-five percent (35%) of the wavelength and up to 100% percent of the wavelength desired to be used for transmission. Because of the wave compression described above, the effective wavelength used to determine the antenna dimension requirements is significantly reduced. Again, this enables a practical dimension antenna for lossy medium transmissions.

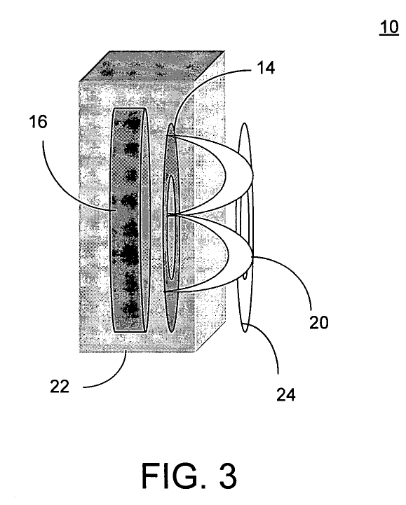

With reference now to FIG. 3, shown is another embodiment of system 10 for communicating through materials. In the embodiment shown, antenna conductor 14 transmits B field. Backing 16 and antenna conductor 14 are shown enclosed in a hermetically sealed, spark-proof enclosure 22. As shown here, antenna conductor 14 is configured as a loop transmitter. Enclosure 22 eliminates the potential hazards from sparks generated by antenna conductor 14. Lens layer 12 may be provided by enclosure 22 itself or by material situated within enclosure 22. For example, lens 12 may be dielectric that fills enclosure 22, or is otherwise deposited in enclosure on front side of antenna conductor 14 (e.g., isolated by plastic coating on antenna conductor 14). Alternatively, lens 22 may be positioned outside of enclosure 22.

Lens 12 and backing 16 create wave compressed, B field 20 transmitted on front side of enclosure 22. The magnetic flux density field 20 induces B field into antenna 24. In other words, system 10 provides an induction system directional beam to drive antenna 24. Enclosed antenna conductor 14 acts as a hermetically sealed inductor into a single element conductor as a primary of a step down transformer (high amps, low volts), that drives antenna 24. In order to provide the secondary of the transformer, a single turn receiver antenna 24 is positioned opposite antenna conductor 14 outside of enclosure 22. Receiver antenna 24 may be configured in same manner as antenna conductor 14 and made from the same material. In this manner, system 10 by non contact magnetically induces a magnetic field in and, therefore, drives antenna 24 without running contacts to antenna 24. By avoiding the use of contacts, system 10 avoids the inherent disadvantages of contacts, including the need for physical connections and sparks that can result. Configured as such, antenna 24 may transmit signals through lossy or non-lossy materials without the hazards of sparks.

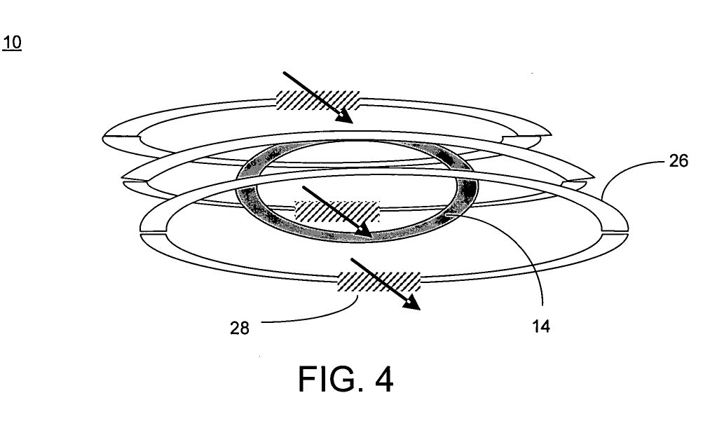

With reference now to FIG. 4, shown is an alternative embodiment of system 10 for communicating through materials. System 10 encloses antenna conductor 14 in conducting cage 26 that includes variable resistors 28. As shown, conducting cage 26 includes multiple conducting rings, each with a variable resistor 28. Variable resistors 28 enable the conductivity of the conducting cage 26 rings to be changed. Specifically, variable resistor 28 can be set to a higher or lower impendence to decrease or increase the conductivity of the conducting cage 26 and of each ring of the conducting cage 26. In this manner, the conducting cage 26 may act as lens 12 above. Accordingly, conducting cage 26 may replace lens 12 and simulate various environments, e.g., salt water, to compress the wavelength of field transmitted by antenna conductor 14, per the principles described above. Conducting cage 26 may be set to lower impendence, and hence higher conductivity, to transmit a signal through lossy materials. The lower impendence will increase the induction of the conducting cage, which changes the wavelength of the B field transmitted by antenna conductor 14. The phase velocity of the B field is determined by 1/√L×C.

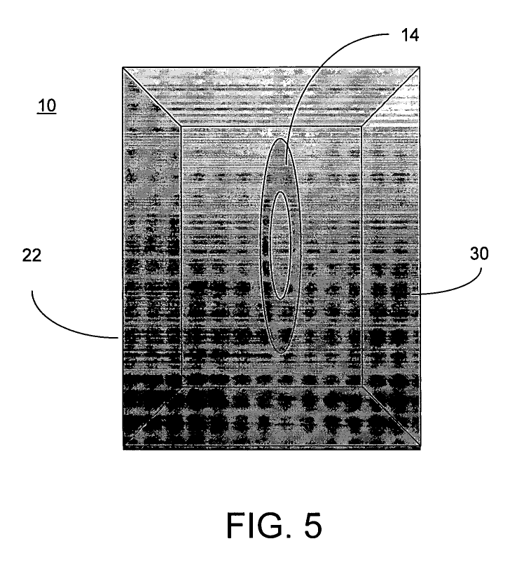

With reference now to FIG. 5, shown is another alternative embodiment of system 10 for communicating through materials. System 10 includes an enclosure 22 that encloses antenna conductor 14 in electrically conductive gel 30 in embodiments for communicating through lossy materials. In embodiments for communicating through non-lossy materials, gel 30 may be a dielectric. The electrically conductive gel 30 may have high magnetic permeability, as described above for lens 12. The electrically conductive gel 30 operates in the manner of lens 12 and conducting cage 26 described above to compress the wavelength of the field transmitted by antenna conductor 14. For communicating through lossy materials, the electrically conductive gel 30 will have an electrical conductivity less than that of antenna conductor 14. As a result of this wave compression, antenna conductor 14 may be made smaller.

What the embodiments shown above illustrate, particularly FIGS. 4 and 5, is that the wave compression affect of system 10 may be achieved in a number of different manners. By providing a system of varying permeability and conductivity as described above, the wave output by antenna conductor 14 may be compressed and the effective wavelength of antenna conductor 14 may be increased. This permits a smaller antenna to be used for a greater wavelength radio wave.

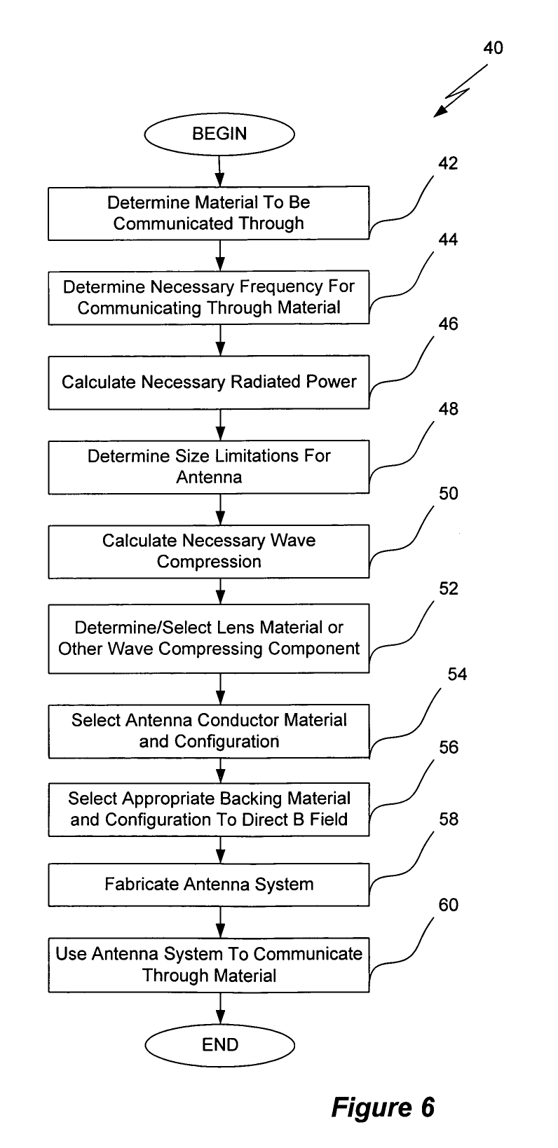

With reference to FIG. 6, shown is an embodiment of method 40 for communicating through materials. Method 40 includes determining the material to be communicated through, block 42. The material may be lossy or non-lossy. Once the material is determined, the necessary frequency for communicating through the material may be determined, block 44. Then the necessary radiated power will be calculated, block 46, using Maxwell's equations, and the losses due to the material and internal reflections (e.g., from coal seams, metal, other materials, clay layers and other layers) taken into account, and necessary antenna aperture and turns determined. Size limitations for the antenna are determined, block 48. For example, the antenna may need to be small enough to carry into a mine or fit on a vehicle. Based on these calculations and size limitations, the necessary wave compression may be calculated, block 50. Based on the necessary wave compression, the lens material, or other wave compressing component, may be determined or selected, block 52. An antenna conductor material and configuration (e.g., loop, spiral, rectangle, etc.) is selected to transmit the necessary signal through the selected lens material, block 54, and an appropriate backing material and configuration (see above) to direct the B field is selected, block 56. An antenna system is fabricated based on these selections, block 58. Once the antenna system is fabricated, it may be used to communicate through the material (e.g., transmit and/or receive signals through the material), block 60.

The embodiments described herein may be used in a variety of applications in which communications through materials is necessary. For example, the embodiments described above may be used to transmit and receive signals from mines beneath the earth. This would enable trapped miners to transmit communication signals to the surface or rescue workers to transmit communication signals to the trapped miners beneath the earth. Likewise, the embodiments described above may be used for transmitting signals to a target area deep into the earth for analyzing what materials are located in the target area (e.g., spectra-graphically). In this manner, deposits of oil, coal, etc. may be located and evaluated much less expensively then before. Because of the wave compression provided, the embodiments described herein provide antenna systems 10 of reasonable and manageable size capable of such communications through materials. As can be determined using the principles and equations described above, such antenna systems 10 are drastically reduced in size from what was previously necessary for such communications through materials. As opposed to hundred or even thousand meter long antennas, the wave compression provided by the embodiments described herein enable the fabrication of portable antenna systems, antenna systems that may be mounted on and transported by vehicles, antenna systems that may be mounted on ships and other sea-going vessels, antenna systems that may be carried into or transported into mines. Such antenna systems may communicate through lossy and non-lossy materials, such as earth, rock, sea, metal, etc., whereas massive and prohibitively expensive antenna systems were required previously.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

1. An antenna system for communicating through materials, comprising:
an antenna conductor that transmits an electromagnetic field bi-directionally;
a lens layer that compresses the wavelength of the electromagnetic field; and
a backing material that re-directs the electromagnetic field in a chosen direction, wherein the re-directed, compressed electromagnetic field has a sufficient frequency and power for the antenna system to effectively sense or transmit through a chosen material.

2. The antenna system of claim 1 in which the antenna conductor is a loop conductor.

3. The antenna system of claim 2 in which the backing material is a continuous loop on a back plane of the antenna conductor.

4. The antenna system of claim 1 in which the antenna conductor is a spiral conductor with conductor segments.

5. The antenna system of claim 4 in which the backing material defines spaces between conductor segments of the antenna conductor so as to prevent mutual inductance between the conductor segments.

6. The antenna system of claim 4 in which the backing material provides channels underneath antenna conductor segments to shield the radiating electromagnetic field so as to prevent mutual inductance between the conductor segments.

7. The antenna system of claim 1 in which the lens layer does not short the antenna conductor.

8. The antenna system of claim 1 in which the chosen material is a lossy material.

9. The antenna system of claim 8 in which the antenna system is portable.

10. The antenna system of claim 8 in which the antenna system is transportable.

11. The antenna system of claim 1 in which the chosen material is earth.

12. The antenna system of claim 1 in which the lens is positioned on a front plane side of antenna conductor.

13. The antenna system of claim 1 in which the lens surrounds the antenna conductor.

14. The antenna system of claim 1 further comprising a hermetically sealed enclosure that encloses the antenna conductor.

15. The antenna system of claim 14 in which the hermetically sealed enclosure includes the lens therein.

16. The antenna system of claim 15 in which the lens is a material substantially filling the hermetically sealed enclosure.

17. The antenna system of claim 16 in which the lens is a liquid.

18. The antenna system of claim 1 in which the antenna system is mounted on a vehicle.

19. The antenna system of claim 1 in which the antenna system is mounted on a ship.

20. The antenna system of claim 1 further comprising a transceiver antenna positioned opposite antenna conductor.

21. The antenna system of claim 20 in which re-directed, compressed electromagnetic field inductively drives transceiver antenna to transmit signals through material.

22. The antenna system of claim 21 in which antenna conductor is hermetically sealed in an enclosure.

23. The antenna system of claim 1 in which the lens is chosen from a list of materials consisting of: powdered iron, hydrochloric acid, salt water, super-saturated salt water, and combinations thereof.

24. The antenna system of claim 1 in which lens is highly electrically conductive.

25. The antenna system of claim 1 in which antenna conductor is more electrically conductive then lens.

26. The antenna system of claim 1 in which lens is highly relatively magnetically permeable.

27. The antenna system of claim 1 in which lens is provided by environment in which antenna system is placed.

28. An antenna system for communicating through materials, comprising:
an antenna conductor that transmits an electromagnetic field bi-directionally, in which the antenna conductor is configured as a loop;
a lens layer that compresses the wavelength of the electromagnetic field, in which the lens layer is highly electrically conductive and highly relatively magnetically permeable;
a backing material that is highly relatively directionally magnetically permeable and re-directs the electromagnetic field in a chosen direction, wherein the re-directed, compressed electromagnetic field has a sufficient frequency and power for the antenna system to effectively sense or transmit through a chosen lossy material; and
an enclosure hermetically enclosing antenna conductor, lens layer and backing material.

29. A method for communicating through materials, comprising:
determining a material to be communicated through;
calculating a necessary frequency and radiated power for communicating through the material;
determining size limitations for antenna;
calculating necessary wave compression, based on size limitations, necessary frequency and radiated power;
selecting wave compressing component;
selecting antenna conductor material and configuration; and
selecting backing material and configuration, wherein the backing material is highly relatively directionally magnetically permeable and re-directs the electromagnetic field in a chosen direction, wherein the re-directed, compressed electromagnetic field has a sufficient frequency and power for the antenna system to effectively sense or transmit through the determined material.

30. The method of claim 29 further comprising fabricating the antenna.

31. The method of claim 30 further comprising using the antenna to communicate through the material.

32. The method of claim 29 in which material is lossy.

33. The method of claim 29 in which the necessary radiated power is determined using Maxwell's equations and the losses due to the material and internal reflections.

34. The method of claim 29 further comprising determining the necessary antenna aperture and turns.

35. The method of claim 29 in which the wave compressing component is a lens and further comprising selecting a lens material.
